(19) United States
(12) Patent Application Publication
(10) Pub. No.: US 2010/0125617 A1
(43) Pub. Date: May 20, 2010

(54) System for Consolidating Business Documents

(76) Inventor: Andrea Alexander, Leesburg, VA (US)

Correspondence Address: GREENBERG & LIEBERMAN, LLC, 2141 WISCONSIN AVE, N.W., SUITE C-2, WASHINGTON, DC, 20007, US

(21) Appl. No.: 12/273,326

(22) Filed: Nov. 18, 2008

(51) Int. Cl. G06F 17/30; G06F 7/00

(52) U.S. Cl. 707/809; 707/E17.001

(57) ABSTRACT

A system for tracking proprietary data relating to optical recognition technology that matches preprogrammed identifiers on paper documents with electronically entered documents in order to provide seamless association and access. This system for businesses—particularly those that order telecommunications services from a telecommunications company—enables companies to consolidate all telecommunications orders, regardless of document layout/format or document file type, into a central repository for better control over network planning and expense management.

### FIELD OF THE INVENTION

The present invention is a system for businesses—particularly those that order telecommunications services from a telecommunications company—that enables companies to consolidate all telecommunications orders, regardless of document layout/format or document file type, into a central repository for better control over network planning and expense management.

### BACKGROUND OF THE PRESENT INVENTION

Traditionally, telecommunications orders have been placed through three key channels:
Fax or email directly to the vendor (results in a paper order or possibly an Excel or other electronic file format that was emailed)
Data entry into vendors' websites (results in an electronic copy of the order in whatever electronic output file/format the vendor provides)
Implementing an automated solution for bonding with larger vendors (current systems are not implemented by all carriers . . . therefore all of these methods are used today)

These various processes have left network planners, provisioners and cost management analysts with the challenge of tracking, managing and validating all orders. In addition, historical orders are sometimes kept in filing cabinets or possibly shipped to an offsite storage facility. Several companies have created online file repositories to store the files (PDF or XLS, etc), but they are still not able to search or query on the data. Some companies have data entry completed to centralize ordering, but it's costly and error-prone. The present invention solves these problems by enabling companies to consolidate all telecommunications orders, regardless of document layout/format or document file type, into a central repository for better control over network planning and expense management. Moreover, in regard to receiving and processing telecommunications orders, the database of the present invention enables companies that receive and process telecommunications orders to eliminate manual entry of orders into the internal OSS/BSS systems as well as retain the order as it was received by the client. Further, the present invention allows companies to store and track subsequent related documents such as the Firm Order Confirmation (FOC) and Design Layout Records (DLRs) that relate to the order and service being provided.

There continues to be a significant disconnect in relation to normalizing and centralizing data contained in paper telecommunications orders and electronic orders. This is particularly prevalent in the telecommunications industry. What happens is that service orders are processed through one of the common methods described above with orders being stored in various locations and formats. Electronic orders may be saved on a company's network and paper orders may be filed or stored in various locations. The problem comes into play because there is no efficient and expedient way for a user to access and extract the information on the paper or electronic orders so that this data reaches a central repository. Further, there is no efficient and expedient way for a user to access and extract the subsequent FOC and DLR documents associated to the order. The present invention solves this problem by enabling companies, particularly those engaged in the telecommunications industry, to retain and store all service orders and associated documents in a central repository for user access.

In this manner, the present invention also solves the problem by adding the non-electronic orders to a database that companies will be able to access while also validating all telecommunications orders. The current problem is related to the fact that paper orders that are scanned must be inspected. At the same time, electronic records in other methods often are incomplete and not recorded in the same manner as paper documents. This is particularly true when a paper document and an electronic document are related in some way. The present invention solves this issue by employing optical character recognition that looks in certain predetermined places for certain identifiers on the paper documents that are scanned into the system. This recognition is compared and the data from all telecommunications orders is extracted through the database of the present invention for data normalizing and centralization.

Another issue is the fact that different networks often come into play, particularly in the telecommunications industry. At the same time, electronic records do not always reflect all relevant information while paper documents typically will. However, it is tedious and inefficient to have to inspect each piece of paper, particularly when relating to the scope of extracting specific data and overall access to a central repository. The present invention permits for the seamless recognition as the data from the paper document is programmed to be derived from that document and collated to become a supplement with the electronic data that had been separately entered.

Also, the database of the present invention provides the following critical benefits:

1) Automation—quickly upload historic and recurring orders, confirmations or design layouts into a common database format

2) Integration—integrate with existing order and provisioning applications (Metasolv, Xng, etc.)

3) Centralized Planning—query on 100% of telecom orders for accurate network planning

4) Validation—include a higher percentage of orders and detailed fields for cost and revenue validation.

5) Efficiency & Accuracy—the most cost effective and accurate method of extracting and consolidating telecom order data.

Currently, there are no systems that effectively satisfy the goals that are met by the present invention. For example, U.S. application Ser. No. 11/333,537 by Devolites is a system and method for intelligent data extraction for telecommunications invoices. However, unlike the present invention, Devolites' relates solely to telecommunication invoices rather than telecommunications order data. In addition, Devolites also relates specifically to the processing of electronic files and does not solve the stated problem of extracting and accessing data from paper documents to be included in a central repository. In contrast, the present invention solves this need by invoking a system for companies to consolidate all telecommunications orders, regardless of document layout/format or document file type, into a central repository for better control over network planning and expense management.

### SUMMARY OF THE PRESENT INVENTION

The present invention relates to proprietary data, particularly non-electronic, paper service orders and electronic orders processed via non-bonded methods. The paper documents are scanned, filed, and organized in a central proprietary database bonding with various applications. Optical character recognition (OCR) is set to recognize specific criteria contained on the paper form and is programmed to know which place on the form to extract data. If an order were non-bonded, according to the preferred embodiment of the present invention it would be parsed for data. If an order is in paper format then the paper order would be OCRed and then parsed. The electronic documents are parsed and organized in a central proprietary database in the same manner as the paper documents are stored. Subsequent documents are then processed in a similar manner and related to the order for a single repository of all order data. In short, businesses employing the system of the present invention can include non-electronic paperwork, particularly service orders, into a database to go along with traditionally filed electronic service orders. The present invention allows users to upload any electronic file format to extract order data and instantly load it into the database of the present invention. The thousands of paper telecommunications orders that companies are storing in filing cabinets or have shipped away to offsite facilities can now have the data extracted (via scan/OCR technology) as well as the electronic orders processed via non-bonded methods, resulting in a 100 percent paperless and centralized environment. If an order were non-bonded, according to the preferred embodiment of the present invention it would be parsed for data. If an order is in paper format then the paper order would be OCRed and then parsed.

How the present invention works is that the OCR scans the paper form, seeking to extract data from specified areas of the form. Indicators can include letters, code, numbers or symbols. Once the indicators are recognized, the OCR will compare it against a template so that the contents of the form can be ingratiated into a central repository database along with a specified electronic form that may already have been submitted into the system via purely electronic format. In addition, access between clients and vendors also is provided whereby various fields contained within the documents can be catered to meet individual needs. Vendors, for example, may modify and create their own order forms based on their internal needs. In the example of telecommunications orders, these business documents may be recognized by modifying various formats with various data requirements and field population guidelines.

It should be noted that the database of the present invention is used by companies to streamline the two critical areas relating to the placing of telecommunications orders and also receiving and processing telecommunications orders. In regard to placing telecommunications orders, the database provides a central repository to retain orders as they were sent to the vendor. Further, the data for companies that place telecommunications orders may be transferred electronically to a company's Operational Support Systems/Business Support Systems (OSS/BSS) solution for tracking and managing inventory. In regard to receiving and processing telecommunications orders, the database of the present invention enables companies that receive and process telecommunications orders to eliminate manual entry of orders into the internal OSS/BSS systems as well as retain the order as it was received by the client.

### BRIEF DESCRIPTION OF THE DRAWINGS

FIG. 1 is a flow chart of the process of the present invention

FIG. 2 is an additional flow chart of the function of the present invention

### DETAILED DESCRIPTION

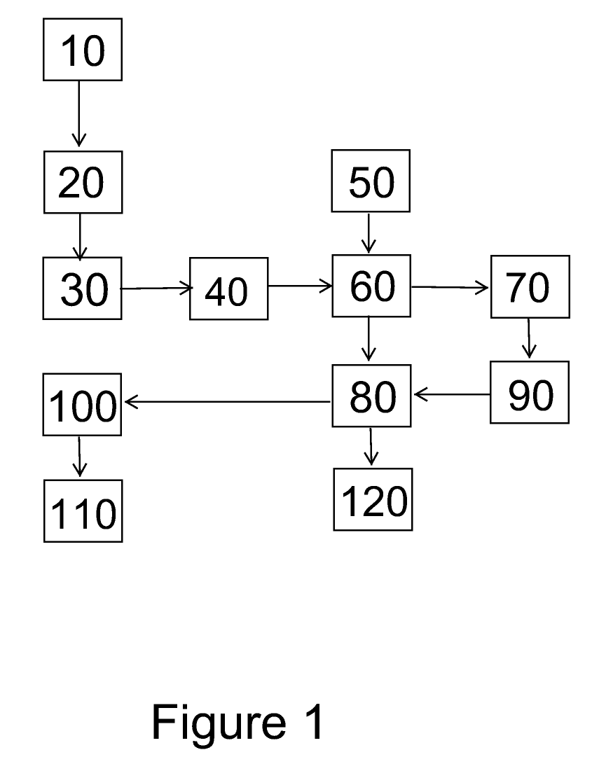

The present invention is a system that permits paper business documents to be scanned and recognized by conventional OCR technology in order to provide seamless consolidation of all telecommunications orders, regardless of document layout/format or document file type, into a central repository database. FIG. 1 is a flow chart of the present invention. Although it can be applied to other types of businesses, the flow chart will relate specifically to telecommunications services from a telecommunications company. It also should be noted that the present invention standardizes such orders for processing with seamless access. For example, the present invention permits vendors to modify and create their own order forms based on their internal needs. In other words, the system of the present invention as described below permits a vendor to cater telecommunications orders in various formats with various data requirements and field population guidelines. Clients also may agree via contract or agreement with vendors to create unique formats or data requirements specific to their individual business needs.

As we see in FIG. 1, a service order, telecom order, etc is made by paper only (10). Paper only (10) means it was literally filled out with a writing utensil, or at least typed up and printed with no connection to a database. The paper order is then sent to a consulting scanning facility (20). The paper is then scanned and converted to electronic format (30) such as PDF or other searchable/text file. The conventional OCR process is then conducted and completed (40) on the paper order. After the OCR process is then conducted and completed (40), the paper order becomes a file in electronic format. This file is then uploaded directly into the system via user interface (60).

Meanwhile, electronic service or telecommunications orders are created (50). The format is inherently electronic and entered into format via such items as spreadsheet, email, text or other order form software relating to data entry. These electronic files also are uploaded directly into the system via user interface (60). If the paper file or the electronic file is rejected, file errors are displayed (70). If this is the case, rejected files folder is used so that the designated IT person can resolve such loading issues. Once the issue is resolved, files are uploaded directly into the system via user interface (90) and effectively return to the path that the initially accepted files were on.

Once the files are accepted, the database of the present invention allows the user to view, search and export all of the orders (80). In an additional embodiment, there is an option to have consolidated files sent to an internal system at selected frequency to include the client's own system (100) or the client's preferred system (110). Otherwise, one or more orders may be exported to a spreadsheet via a conventional graphical user interface (GUI) (120).

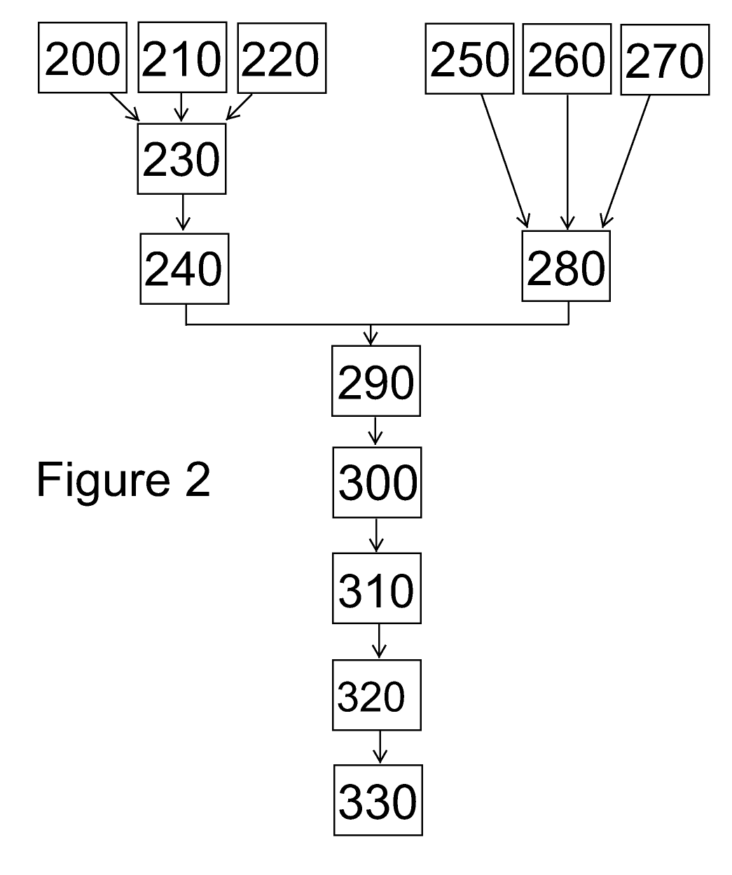

FIG. 2 is a flowchart that offers a more nuanced view of the present invention. Again using the example of the telecommunications industry and telecommunications order forms, paper documents relating to industry standard (200) or paper documents relating to unique vendor and service type (220) are created. The paper documents are scanned (230) and the paper documents are converted to the searchable/text file (240) as described above. Meanwhile, electronic forms are completed via spreadsheet that is industry standard (250), spreadsheet relating to unique vendor and service type (260) or text relating to unique vendor and service type (270). Meanwhile, all the electronic documents are confirmed to be searchable/text files (280). From there, all documents are placed in unique format identified based on pre-defined rules (290). Code determines parser to use based in format identified (300). The file is parsed and mapped to a corresponding import file (310) and the import file is loaded into a database (320). The central repository database then stores all the files in unified format (330).

As we see in FIG. 2, the unique format is based on file layout, fields, graphics and other unique characteristics of each order or document. In this manner the code using conventional OCR technology will identify the type of document and extract data. For example, the code will identify the type of telecommunications order to include elements such as version, vendor and corresponding parser to use. These pre-defined rules are coded into the application via conventional means. The pre-defined rules are based primarily on analysis of format such as paper or electronic, vendor and service type. In the area of telecommunications, this would include such items as local, long distance, access, etc. Constant coding also must be conducted as various order formats are changed. In telecommunications, this is at least twice per year, and therefore analysis and additional business rules must be created and coded in order to identify the format and select the correct parser.

It also should be noted that a user of the present invention could upload, attach, parse and load documents or files directly into the conventional software application. This is in contrast to merely the parsing happening outside of the central repository database and being loaded into a batch file. In the present invention, when the file is attached, that is when it becomes parsed and fielded into the central repository database. The present invention also includes a series of checks to make sure it finds the correct field for standard and non-standard documents. This means that while the key form layout is analyzed, other aspects such as the field name and field value/length/characteristics also are checked.

Even more specifically, the present invention associates an access service request with a firm order confirmation and with a design layout record. For example, in the telecommunications industry, a typical service order is placed from a first carrier to a second carrier. The initiation of a service order that is placed is typically referred to as an access service request. Sometimes, an access service request is bonded, meaning that it is electronically linked to other forms associated to other access service request. However, oftentimes, the access service request is not bonded or even provided on paper. When carrier two receives the access service request, carrier two then sends back to carrier one a firm order confirmation. Much like the access service request, the firm order confirmation is often not bonded or in paper format. Moreover, carrier two typically also provides a design layout record to carrier one, although sometimes the design layout record could be provided by carrier one to carrier two. Thus, a complete service order is an access service request, a firm order confirmation and a design layout record. The present invention allows one telecommunications carrier to confirm or reject claims by another telecommunications carrier regarding unpaid orders. The present invention does this by capturing all parts of an order. Thus, a carrier always has knowledge of all aspects of an order. The present invention matches access service requests, firm order confirmations and design layout records together. The present invention identifies access service requests, firm order confirmations, and design layout records and matches them to one another so that billing information for a service order can be validated. A circuit might have many access service requests, firm order confirmations and design layout records, with the present invention putting them all together and not just one subset of an access service request, firm order confirmation and a design layout record. It should be recognized that any and all operations and methods that enable the present invention are conventional in nature. The present invention allows for all related orders and subsequent documents to be to be quickly identified.

In short, the present invention provides optical character recognition on all paper orders, and then parses the data. All electronic orders are also parsed. A centralized database then queries all paper and all electronic orders because they have been parsed—and all orders per circuit are associated.

I claim:

1. A system for consolidating business documents, comprising:
sending paper service orders to scanning facility;
scanning the paper service orders;
converting the paper service orders that had been scanned into an electronic format;
reviewing and extracting data from the electronic format;
creating electronic service orders;
uploading the electronic service orders directly into a database;
matching at least one of access service requests, firm order confirmations, and design layout records together for the same service orders;
searching, viewing, extracting, and exporting data from the electronic format and the electronic service orders such that all of the data is consolidated within the central repository database; and
accessing the data.

2. The system for consolidating business documents of claim 1, further comprising reviewing and extracting the data via optical character recognition.

3. The system for consolidating business documents of claim 1, further comprising confirming that the electronic service orders and the electronic format of the paper service orders are searchable/text files.

4. The system for consolidating business documents of claim 1, further comprising placing the electronic service orders and the electronic format of the paper service orders into a unique format identified based on pre-defined rules.

5. The system for consolidating business documents of claim 4, further comprising determining parser to use based in the format identified via code.

6. The system for consolidating business documents of claim 1, further comprising determining parser to use based in the format identified via code.

7. The system for consolidating business documents of claim 3, further comprising parsing and mapping the searchable/text files to a corresponding import file.

8. The system for consolidating business documents of claim 1, further comprising parsing and mapping the searchable/text files to a corresponding import file.

9. The system for consolidating business documents of claim 7, further comprising loading the import file into the database.

10. The system for consolidating business documents of claim 1, further comprising loading the import file into the database.

11. The system for consolidating business documents of claim 1, further comprising storing the files in a unified format within the central repository database.

12. The system for consolidating business documents of claim 3, further comprising identifying the type of document and extracting the data via OCR code.

13. The system for consolidating business documents of claim 4, further comprising basing the pre-defined rules primarily on analysis of format and type of the document.

14. The system for consolidating business documents of claim 1, further comprising basing the pre-defined rules primarily on analysis of format and type of the document.

15. The system for consolidating business documents of claim 1, further comprising allowing a user to upload, attach, parse and load the documents or the files directly into a conventional software application.

16. The system for consolidating business documents of claim 1, further comprising parsing and fielding the file into the central repository database when the file is attached.

17. The system for consolidating business documents of claim 1, further comprising matching the access service requests, the firm order confirmations and the design layout records together if the access service requests, the firm order confirmations and the design layout records are for a same circuit or service.

18. The system for consolidating business documents of claim 1, further comprising allowing one telecommunication carrier to confirm claims by another telecommunications carrier regarding unpaid orders.

19. The system for consolidating business documents of claim 1, further comprising allowing one telecommunication carrier to reject claims by another telecommunications carrier regarding unpaid orders.

20. A system for consolidating business documents, comprising:
sending paper service orders to scanning facility;
scanning the paper service orders;
converting the paper service orders that had been scanned into an electronic format;
reviewing and extracting data from the electronic format;
creating electronic service orders;
uploading the electronic service orders directly into a database;
matching access service requests, firm order confirmations and design layout records together for the same service orders;
searching, viewing, extracting, and exporting data from the electronic format and the electronic service orders such that all of the data is consolidated within the central repository database;
accessing the data;
reviewing and extracting the data via optical character recognition;
confirming that the electronic service orders and the electronic format of the paper service orders are searchable/text files;
placing the electronic service orders and the electronic format of the paper service orders into a unique format identified based on pre-defined rules;
determining parser to use based in the format identified via code;
parsing and mapping the searchable/text files to a corresponding import file;
loading the import file into the database;
loading the import file into the database;
storing the files in a unified format within the central repository database;
identifying the type of document and extracting the data via OCR code;
basing the pre-defined rules primarily on analysis of format and type of the document;
allowing a user to upload, attach, parse and load the documents or the files directly into a conventional software application;
parsing and fielding the file into the central repository database when the file is attached;
matching the access service requests, the firm order confirmations and the design layout records together if the access service requests, the firm order confirmations and the design layout records are for a same circuit;
allowing one telecommunication carrier to confirm claims by another telecommunications carrier regarding unpaid orders; and
allowing one telecommunication carrier to reject claims by another telecommunications carrier regarding unpaid orders.
